(19) United States
(12) Patent Application Publication
(10) Pub. No.: US 2012/0301065 A1
(43) Pub. Date: Nov. 29, 2012

(54) ROLLING BEARING LUBRICATION STRUCTURE AND ROLLING BEARING

(75) Inventors: Masatsugu Mori, Kuwana-shi (JP); Tetsuto Ishii, Kuwana-shi (JP)

(73) Assignee: NTN Corporation, Osaka (JP)

(21) Appl. No.: 13/579,465

(22) PCT Filed: Feb. 10, 2011
(86) PCT No.: PCT/JP2011/052943

§ 371 Date: Aug. 16, 2012

(30) Foreign Application Priority Data
Feb. 17, 2010 (JP) 2010-032258
Mar. 29, 2010 (JP) 2010-074325

(51) Int. Cl. F16C 33/66; F16C 19/04

(52) U.S. Cl. 384/469

(57) ABSTRACT

A lubrication structure for a rolling bearing assembly of low manufacturing cost, high speed and the environment-friendly is provided. An inclined surface portion is provided in an outer diametric surface of an inner ring of the bearing assembly, and a grease tank having a grease reservoir is arranged adjacent to an outer ring of the rolling bearing assembly. A base oil transfer medium for moving a base oil in the grease by capillary phenomenon is provided within the grease reservoir, and one end thereof contacts the inclined surface portion. Accordingly, the base oil within the grease reservoir adheres to the inclined surface portion through the base oil transfer medium, and the base oil adhering to the inclined surface portion is supplied to the bearing assembly utilizing surface tension of the base oil and the flow of the base oil induced upon rotation of the inner ring.

### CROSS REFERENCE TO THE RELATED APPLICATIONS

This application is based on and claims Convention priority to Japanese patent applications No. 2010-032258, filed Feb. 17, 2010, and No. 2010-074325, filed Mar. 29, 2010, the entire disclosures of which are herein incorporated by reference as a part of this application.

### BACKGROUND OF THE INVENTION

1. Field of the Invention

The present invention relates to a lubrication structure in a rolling bearing of a kind used to support a high speed spindle such as, for example, a machine tool main shaft and also to a rolling bearing assembly equipped with a sealing device that is lubricated with a grease.

2. Description of Related Art

Machine tools currently made available in the market are increasingly developed to have a capability of being operated at a high speed to exhibit the increased processing efficiency and, accordingly, even some bearing assemblies used with main shafts thereof are desired to be compatible with a high-speed trend to afford this capability. Also, environment related issues such as those related with energy saving and resource saving are increasingly coming under close scrutiny. With respect to the high-speed trend and the environment related issues, an important concern in the bearing assembly is focused on the lubricating method. The lubricating method that can be employed with the prevailing bearing assembly for supporting a main shaft includes a grease lubrication system, an air oil lubrication system in which a fluid mixture containing oil mixed with a compressed air is jetted through a nozzle into a bearing assembly, and a jet lubrication system in which oil is directly jetted into a bearing assembly with the use of a nozzle. Those lubrication systems have good and bad points as discussed below.

Although the grease lubrication system can be handled conveniently, it is not adequate to the bearing assembly that rotates at a high speed when in use. The air oil lubrication system, although applicable to the bearing assembly that rotates at a high speed, appears to be problematic in terms of energy saving and environment related concern as it requires a substantial amount of compressed air and accompanies generation of oil mist and noses. The jet lubrication system, although capable of allowing the bearing assembly to be rotated at the highest speed of all afforded by those three lubrication systems, appears to be problematic in terns of energy saving and resource saving as is the case with the air oil lubrication system since it requires incidental equipment such as, for example, an oil supply device and accompanies a considerable power loss because of the use of a substantial amount of oil.

In view of the foregoing, the conventional lubrication systems discussed above have their own problems and, therefore, a novel lubricating method has recently been suggested, which is compatible with the high-speed trend and the environment related issues. In this respect, see the patent document 1 listed below. According to the lubricating method disclosed in the patent document 1 is such that, while a grease tank accommodating an amount of grease filled therein is used and disposed adjacent to the bearing assembly, utilizes the heat cycle occurring within the bearing assembly to separate a base oil from the grease within the grease tank and then to discharge the separated base oil into the bearing assembly.

Also, as an attempt to increase the speed of the bearing assembly that is lubricated with grease, the patent document 2 listed below suggests designing an inner diametric surface of a retainer and/or an outer diametric surface of an inner ring to represent an inclined surface structure having its diameter increasing as it approaches from an end face towards the center thereof, so that by a pumping action an oil mist can be directed towards rolling elements.

### PRIOR ART DOCUMENTS

[Patent Document 1] JP Laid-open Patent Publication No. 2009-103232
[Patent Document 2] JP Laid-open Patent Publication No. 2006-161943

### SUMMARY OF THE INVENTION

In the practice of the lubricating method disclosed in the patent document 1 referred to above, the grease tank is disposed on the side of the front of the bearing assembly particularly where the latter is an angular contact ball bearing. In general, in supporting a main shaft of a machine tool, a pair of angular contact ball bearings are often employed in back-to-back relation with each other. Accordingly, when the bearing assembly and the grease tank are assembled into the main shaft of the machine tool, the distance from a tool, fitted to a tip of the main shaft, to the bearing assembly tends to increase by a quantity corresponding to the size of the grease tank. The distance so increased as discussed above poses a problem in terms of the moment rigidity of the main shaft.

In view of the above, the lubricating method is contemplated, in which so that the lubricant oil can be supplied from the side of the rear of the bearing assembly into the bearing assembly, oil within an oil tank disposed outside is directed towards an oil supply member that is disposed in the axial vicinity of the bearing assembly (for example, on the side of the rear of the bearing assembly) and a tip of a capillarity inducing member accommodated within the oil supply member is brought into contact with the outer diametric surface of the inner ring in the bearing assembly to allow the lubricant oil, introduced into the oil supply member, to be supplied into the bearing assembly along the capillarity inducing member. It has, however, been found that this contemplated lubricating method has a problem in that it requires the use of the oil tank and a fluid circuit for guiding the lubricant oil from the oil tank to the oil supply member, resulting in the increase of cost.

Also, the rolling bearing assembly, disclosed in the above mentioned patent document 2, as well as the bearing assembly that is lubricated with a grease is generally of a structure in which a quantity of grease filled in during the assemblage of such bearing assembly exists in a raceway surface (rolling surface) in a raceway rings forming parts of the rolling bearing, and, therefore, the rolling bearing is used in practice after it has been broken in. At this time, the grease present on the rolling surface is trodden upon by rolling elements and does therefore get in part paddled sideways outwardly by the rolling element and in part scattered to adhere to respective inner wall faces of sealing members provided at both ends of the bearing assembly.

Although the most part of the base oil separated from the grease still remaining on the raceway ring is supplied to the rolling surface for consumption in lubrication, the grease adhering to the inner wall faces of each of the sealing devices (which grease is hereinafter referred to as “sealer wetting grease”) makes a small contribution towards the lubrication. Considering that in the most cases the lifetime of the bearing assembly lubricated with the grease, if the lubrication is carried out under a proper condition of use, depends on the lifetime of the grease, the lifetime of the bearing assembly can be prolonged with the same amount of the filled grease as that hitherto employed, provided that the sealer wetting grease referred to above be efficiently utilized.

In view of the foregoing, the present invention has been devised to provide a lubrication structure in a rolling bearing assembly which utilizes a base oil transfer medium to thereby enable both of the speeding up of the bearing assembly and the environmental related issues to be resolved by the lubrication structure and also which can be manufactured at a low cost.

Another important object of the present invention is to provide a rolling bearing assembly, in which in a sealing device equipped rolling bearing assembly of an inner ring rotating type that is lubricated with grease, the base oil transfer medium is utilized so that the base oil of the sealer wetting grease can be efficiently utilized to eventually increase the lifetime of the bearing assembly.

In order to accomplish the foregoing objects of the present invention, one aspect of the present invention provides lubrication structure for a rolling bearing assembly that has inner and outer rings; a plurality of rolling elements interposed between those inner and outer rings, including: an inclined surface portion defined in an outer diametric surface of the inner ring that serves as a rotating member and extending laterally from a rolling surface of the inner ring; a grease tank having a grease reservoir defined therein, the grease tank being disposed adjacent the outer ring of the rolling bearing assembly; and a base oil transfer medium disposed within the grease reservoir of the grease tank for transferring a base oil of the grease by means of a capillary phenomenon, in which the base oil transfer medium has one end held in contact with the inclined surface portion to allow the base oil of the grease, filled within the grease reservoir, to be transferred through the base oil transfer medium to adhere to the inclined surface portion, whereby the base oil adhering to the inclined surface portion is supplied into the rolling bearing assembly by the utilization of a surface tension of the base oil and the attachment flow of the base oil along the inclined surface portion that is induced upon rotation of the inner ring.

The lubrication structure of the construction described above, during the assemblage, the grease is filled into the inside of the rolling bearing assembly and, at the same time, the grease is filled in the grease reservoir of the grease tank. Lubrication of the bearing assembly is carried out by the utilization of the initially filled grease and the grease within the grease reservoir. The base oil contained in the grease within the grease reservoir adheres to the inclined surface portion of the inner ring by means of the base oil and transfer that occur by the effect of the capillarity exhibited by the base oil transfer medium. The base oil adhering to the inclined surface portion flows along the inclined surface portion to a direction of the inside of the bearing assembly under the influence of a centrifugal force generated upon rotation of the inner ring and the surface tension possessed by the base oil and is subsequently utilized as a lubricant oil. In this way, since in addition to the initially filled grease within the inside of the bearing assembly, the grease reservoir contains an amount of the grease, the reliability of lubrication is high and the increase of the lifetime of the bearing assembly can be realized.

This lubrication structure is such that the grease tank may be disposed either a front side or a rear side of the rolling bearing assembly particularly where the rolling bearing assembly is a bearing assembly of a type having a contact angle such as, for example, an angular contact ball bearing. In general, for the support of a main shaft of a machine tool, it is quite often that a pair of angular contact ball bearing are employed in back-to-back relation to each other. In such case, when the grease tank is disposed on the rear side of the rolling bearing assembly, it is possible to employ a design in which the distance from the rolling bearing assembly to the tip of the main shaft is minimal. In the machine tool, a tool is fitted to the tip of the main shaft. If the distance from the rolling bearing assembly to the tip of the main shaft is small, the moment rigidity relative to an external force load acting on the tool is large and, therefore, it is structurally advantageous.

Since the base oil of the grease filled in the grease reservoir of the grease tank is used as a lubricant oil, neither an oil tank nor any piping is needed outside. There is also no need to process any oil introducing hole or the like in a bearing box. For this reason, the structure is simplified and can be manufactured inexpensively. Also, since no substantial amount of oil is used and since no operating power for the lubrication is required, it is preferred in terms of energy saving and resource saving. Also, no maintenance servicing is needed because of the grease lubrication.

In one embodiment of the present invention, the grease tank may have a medium insertion gap defined therein for communicating the grease reservoir to the outside, the base oil transfer medium being inserted in this medium insertion gap; an outer diametric side portion of the medium insertion gap in a shell of the grease tank is formed as a tubular portion that covers the inclined surface portion of the inner ring through a gap area; and an inner diametric surface of a portion of the tubular portion, which protrudes axially towards a center of the bearing assembly beyond the medium insertion gap, is so shaped as to guide a portion of the base oil transfer medium outside the grease reservoir to have a tip held in contact with the inclined surface portion.

When the base oil transfer medium is inserted in the medium insertion gap defined in the grease tank, the base oil contained in the grease can be drawn outwardly into the grease reservoir along the base oil transfer medium while avoiding an undesirable leakage of the grease or the base oil from the grease reservoir. If the grease tank is formed with the tubular portion and an inner diametric surface thereof has a tip that is so shaped that a portion of the base transfer medium outside the grease reservoir can be guided so as to contact the inclined surface portion, one end of the base oil transfer medium can be assuredly held in contact with the inclined surface portion.

In one embodiment of the present invention, the inclined surface portion may be provided with a generally V-sectioned circumferential groove, and one end of the base oil transfer member is held in contact with a inclined face of the circumferential groove that is adjacent the rolling surface.

The provision of the circumferential groove in the inclined surface portion is effective to allow both of the base oil, then adhering to the inclined surface portion of the inner ring, and the base oil, extracted from the grease within the grease reservoir along the base oil transfer medium, to be temporarily retained within the circumferential groove at the time the operation is halted. At the time of starting of the operation, the oil retained within the circumferential groove can be again used as the lubricant oil and, therefore, the lubrication can be accomplished at all time with an abundant amount of the lubricant oil. If the circumferential groove is so shaped as to represent a generally V-sectioned configuration, the base oil discharged from one end of the base oil transfer medium onto a portion of the inclined surface of the circumferential groove on one side adjacent the rolling surface can be easily transferred onto the inclined surface portion of the outer diametric surface of the inner ring. The inclination angle of the inclined surface of the circumferential groove is determined in dependence on the practical rotational speed of the inner ring. More specifically, the higher the velocity, the inclination angle is increased.

In one embodiment of the present invention, the inclined surface portion may be provided with a stepped area having a small diameter thereof at a location remote from the rolling surface, one end of the base oil transfer medium being held in contact with a stepped face of this stepped area. In a broad sense, the stepped area is a part of the inclined surface portion.

In this case, owning to the use of the base oil transfer medium, the base oil extracted from the grease within the grease reservoir adheres to the stepped area of the inner ring. The base oil so adhering to the stepped area shifts from the stepped area onto the inclined surface portion, then move towards the inside of the bearing assembly along the inclined surface portion, and is finally used as a lubricant oil. In this way, the provision of the stepped area in the inclined surface portion is effective to temporarily retain the oil in the stepped area at the time of halt of the operation in a manner similar to that described previously, allowing the lubrication to be accomplished with an abundant amount of the lubricant oil.

In one embodiment of the present invention, it is recommended that when the angle of the inclined surface portion relative to a bearing longitudinal axis is expressed by α (°), the pitch circle diameter of the rolling elements is expressed by dₘ (mm) and the rotational velocity is expressed by n (min⁻¹), the following equation establishes:

α≧{0.056×dₘ×n×10⁻⁴}−2

A preferred value of the angle of the inclined surface portion in the inner ring outer diametric surface varies depending on the dₘ·n value of the bearing assembly. As a result of experiments, it has been ascertained that the angle α of the inclined surface portion is preferred to be the value expressed by the above equation. It is to be noted that the dₘ·n value is a numerical value representing the extent of high speed of a condition of use of the radial bearing assembly and is expressed by the product of the average value dₘ between the bearing inner diameter and outer diameter multiplied by the allowable rotational velocity n.

In the present invention, as the material for the base oil transfer medium, at least one selected from the group consisting of Japanese Washi paper, a textile fabric including a non-woven fabric, and leather can be used. It is to be noted that Japanese Washi paper referred to above and hereinafter means a Japanese paper prepared from a vegetable material such as, for example, linen, kouzo plant, or mitsumata plant.

Any of those materials has a property of extracting the base oil from the grease and then contain it and a property of transferring the contained base oil by the effect of the capillarity. For this reason, such material is suitably used as the material for the base oil transfer medium for extracting the base oil from the grease and then guiding it towards the inclined surface portion of the inner ring outer diametric surface.

In one embodiment of the present invention, the base oil transfer medium may be provided in the grease tank such that the circumferential length of a portion of the base oil transfer medium, which contacts the inclined surface portion, is adjustable.

If the circumferential length of the contact portion, where the base oil transfer medium contacts the inclined surface portion, is adjustable, the adjustment of such circumferential length is effective to adjust the amount of the oil adhering to the inner ring inclines surface area.

In one embodiment of the present invention, a portion of the base oil transfer medium within the grease reservoir may be branched into a plurality of branched portions that are separated from each other in a direction circumferentially thereof.

If that portion of the base oil transfer member remaining within the grease reservoir is branched as described above, the individual branched portions can be arranged having been dispersed over a large region within the grease reservoir and, therefore, the base oil can be efficiently extracted from all over the grease reservoir.

Another aspect of the present invention provides a rolling bearing assembly that has inner and outer rings; a plurality of rolling elements interposed between those inner and outer rings, including: a sealing device provided in the outer ring for sealing a bearing space delimited between the inner and outer rings; an inclined surface portion defined in an outer diametric surface of the inner ring; and having diameters gradually increasing from an end face side towards a rolling surface side a base oil transfer medium of an annular shape made of a material capable of giving rise to a capillary phenomenon and provided in an inner wall face of the sealing device, at least a part of or the whole of the circumference of an inner peripheral edge portion of the base oil transfer medium being held in contact with an inclined surface portion of an outer diametric surface of the inner ring that serves as a rotatable member.

The grease is filled in the bearing space delimited between the inner and outer rings. The grease present on the rolling surface as a result of operation of the bearing assembly is trodden upon by rolling elements and does therefore get in part paddled sideways outwardly by the rolling elements and in part scattered before it adhere to an inner wall face of the sealing device provided at both ends of the bearing assembly.

According to this construction, since the base oil transfer medium for transferring the base oil of the grease is provided at the inner wall surfaces of the sealing device and the inner peripheral edge portion of the base oil transfer medium is caused to contact the inclined surface portion, which is defined in the outer diametric surface of the inner ring so as to have a diameter gradually increasing as it goes from an end face side towards the rolling surface (raceway surface), only the base oil of the sealer wetting grease adhering to the inner wall face of the sealing device, that is required for the lubrication, can be caused to adhere to the inclined surface portion through the base oil transfer medium by the effect of the capillarity. When the inner ring rotates, the base oil adhering to the inclined surface portion can contribute to the lubrication by the utilization of the centrifugal force and the surface tension. Accordingly, as compared with the conventional sealing device equipped rolling bearing assembly filled with the same amount of grease as that in the rolling bearing assembly of the present invention, the prolonged lifetime can be achieved.

Since the inner peripheral edge portion of the base oil transfer medium contacts the inclined surface portion, upon rotation of the inner ring, the base oil then adhering to the inclined surface portion of the inner ring outer diametric surface is urged to flow towards a large diameter side, that is, towards the rolling surface of the inner ring while adhering to the inclined surface portion, by the effect of the centrifugal force and the surface tension. In the description that follows, the flow of the base oil by the effect of the centrifugal force and the surface tension is referred to as “attachment flow”.

Owning to the above two functions, that is, the function of the capillary phenomenon and the function of the attachment flow, the sealer wetting grease contributes to the lubrication of the bearing assembly. If the bearing assembly is broken in, the base oil in the sealer wetting grease is supplied to the inclined surface portion through the base oil transfer medium by the effect of the capillary. The base oil so supplied to the inclined surface portion of the inner ring outer diametric surface moves towards the center of the bearing assembly by the effect of the attachment flow, thus contributing to the lubrication.

The inclination angle of an inclined surface of an outer diametric surface of the inner ring may be such an angle that, when the bearing assembly is rotated at a permissible rotational velocity or a service rotational velocity, the base oil may flows towards a rolling surface by the effect of a centrifugal force. The term “allowable rotational velocity” referred to hereinbefore and hereinafter is a value described in the specification, which set forth guidelines of use of the rolling bearing assemblies, and is determined in dependence on the bearing size. The centrifugal force acting on the grease varies depending on the rotational velocity. More specifically, the higher the rotational velocity, the higher the centrifugal force acting on the grease then adhering to the inclined surface, and, thus, the base oil supplied to the inclined surface portion is apt to move towards the center of the bearing assembly, contributing considerably to the lubrication.

Both of the base oil transfer medium and an inclined surface of the outer diametric surface of the inner ring may be provided only on one side or on opposite sides of the bearing assembly.

Also, when the angle of the inclined surface portion relative to a bearing longitudinal axis is expressed by α (°), the pitch circle diameter of the rolling elements is expressed by dₘ (mm) and the rotational velocity is expressed by n (min⁻¹), the following equation may establish:

α≧{0.056×dₘ×n×10⁻⁴}−2

The above equation is based on the result of experiments which have been conducted with the use of quasi-inner rings of bearing assemblies, 70 mm and 100 mm in diameter, which have respective inclined surfaces. Each of those experiments was conducted by adhering an oil to the inclined surface portion of each of the inner rings (the angle of which has been changed) by the utilization of an air oil and then observing the presence or absence of an attachment flow with naked eyes. As a way of thinking of the attachment flow on the inclined surface, it is suspected that the oil of the air oil and the base oil of the grease make no difference if it attaches to the inclined surface.

The material for the base oil transfer medium may be chosen to be at least one selected from the group consisting of Japanese Washi paper, a textile fabric including a non-woven fabric and leather.

The sealing device may be rendered to be non-contact relative to the outer diametric surface of the inner ring. By way of example, in the case of a bearing assembly for use in machine tools and a bearing assembly for use in motors used in general industrial machines, it is recommended to render the sealing device to be of a non-contact type.

The sealing device may be designed to contact the outer diametric surface of the inner ring. By way of example, in the case of a bearing assembly for use in railroad vehicles, a bearing assembly for use in automotive vehicles and a bearing assembly for use in wind mills, all of which generally attach importance to the water proofing and the dust proofing, it is recommended to render the sealing device to be of a contact type.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a longitudinal sectional view showing a lubrication structure employed in a rolling bearing assembly designed in accordance with a first embodiment of the present invention;

FIG. 2 is a longitudinal sectional view showing on an enlarged scale the lubrication structure employed in the rolling bearing assembly;

FIG. 3 is a schematic end view as viewed in an axial direction, showing one example of a base oil transfer medium, which medium is employed in the lubrication structure in the rolling bearing assembly;

FIG. 4 is a schematic end view as viewed in the axial direction, showing a different example of the base oil transfer medium, which medium is employed in the lubrication structure in the rolling bearing assembly;

FIG. 5 is a schematic longitudinal sectional view showing a main shaft device utilizing the lubrication structure in the rolling bearing assembly;

FIG. 6 is a longitudinal sectional view showing an important portion of the lubrication structure in the rolling bearing assembly designed in accordance with a second embodiment of the present invention;

FIG. 7 is a view showing a portion of the base oil transfer medium in the lubrication structure, which portion is developed in a plane in a circumferential direction;

FIG. 8 is a schematic longitudinal sectional view showing an important portion of the lubrication structure in the rolling bearing assembly designed in accordance with a third embodiment of the present invention;

FIG. 9 is a schematic longitudinal sectional view showing an important portion of the lubrication structure in the rolling bearing assembly designed in accordance with a fourth embodiment of the present invention;

FIG. 10 is a schematic longitudinal sectional view showing an important portion of the lubrication structure in the rolling bearing assembly designed in accordance with a fifth embodiment of the present invention;

FIG. 11 is a longitudinal sectional view showing the rolling bearing assembly designed in accordance with a sixth embodiment of the present invention;

FIG. 12 is a longitudinal sectional view showing on an enlarged scale an important portion of the rolling bearing assembly shown in FIG. 11;

FIG. 13A is a longitudinal sectional view showing the rolling bearing assembly designed in accordance with a seventh embodiment of the present invention;

FIG. 13B is a schematic end view as viewed in the axial direction, showing only an inner peripheral edge portion of the base oil transfer medium in the rolling bearing assembly of FIG. 13A;

FIG. 14 is a schematic end view as viewed in the axial direction, showing only the inner peripheral edge portion of the base oil transfer medium in the rolling bearing assembly designed in accordance with an eighth embodiment of the present invention;

FIG. 15 is a longitudinal sectional view showing the rolling bearing assembly designed in accordance with a ninth embodiment of the present invention;

FIG. 16 is a longitudinal sectional view showing the rolling bearing assembly designed in accordance with a tenth embodiment of the present invention; and

FIG. 17 is a longitudinal sectional view showing the rolling bearing assembly designed in accordance with an eleventh embodiment of the present invention.

### DESCRIPTION OF THE EMBODIMENTS

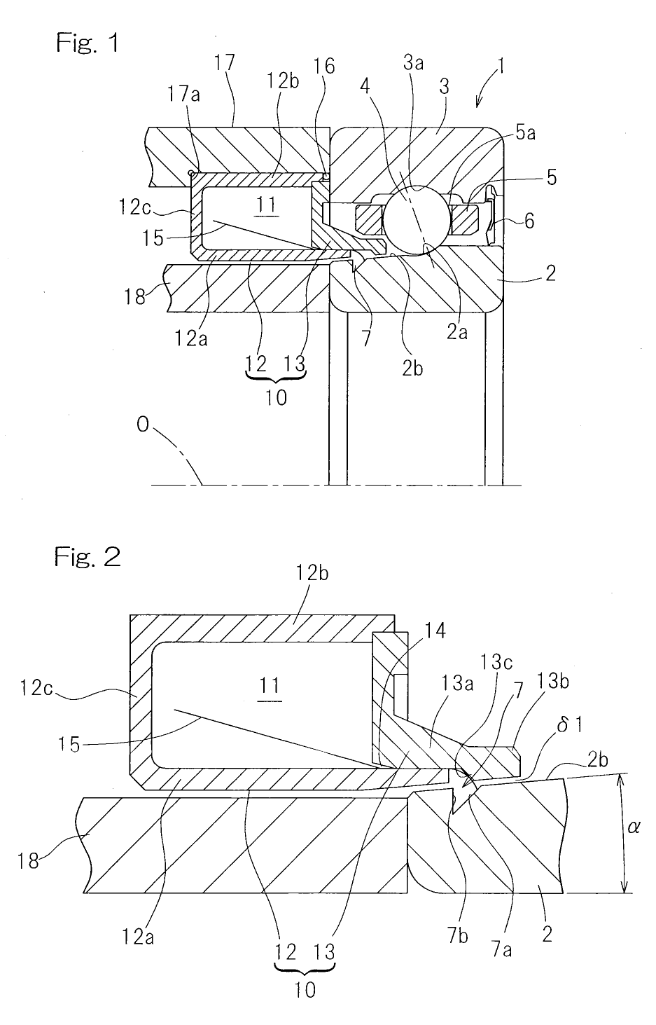

A first embodiment of the present invention will now be described in detail with particular reference to FIGS. 1 and 2. FIG. 1 illustrates a longitudinal sectional view of a lubrication structure in its entirety that is used in a rolling bearing assembly and FIG. 2 illustrates a fragmentary enlarged view of an important portion of such lubrication structure. The lubrication structure employed in the rolling bearing assembly is applied to a rolling bearing assembly 1, which is shown in the form of an angular contact ball bearing, and a grease tank 10 is disposed at a location rearwardly of and adjacent to the rolling bearing assembly 1.

The rolling bearing assembly 1 shown therein includes an inner ring 2, an outer ring 3 and a circular row of rolling elements 4 rollingly interposed between respective rolling surfaces 2a and 3a of the inner and outer rings 2 and 3. The rolling elements 4 are employed in the form of balls and are accommodated and hence retained within in respective pockets 5a in a ball retainer 5. An annular bearing space delimited between the inner and outer rings 2 and 3 has a front open end of such annular bearing space being sealed by a first sealing member 6 which forms a sealing device. On a rear side of the bearing assembly, the grease tank 10 referred to above and positioned rearwardly of and adjacent to the rolling bearing assembly 1 concurrently serves as a sealing member and, hence, the rear open end of the annular bearing space is not provided with any other sealing member. The inner ring 2, the outer ring 3 and the rolling elements 4 are made of steel material such as, for example, a bearing steel or ceramic material. The ball retainer 5 is made of a resinous material or the like.

The inner ring 2 has an outer diametric surface formed with a rolling surface 2a, and a portion of the outer diametric surface of the inner ring 2 adjacent the rear open end of the annular bearing space is so shaped as to represent an inclined surface portion 2b having diameters gradually decreasing towards an axially outside. The angle α (°) of the inclined surface portion 2b relative to the longitudinal axis O of the bearing assembly 1 is determined in dependence on the practical rotating velocity of the inner ring 2. More specifically, the higher the practical rotating velocity, the greater the angle α. By way of example, if the maximum rotating velocity during the use is 2000000 when expressed by the dₘ·n value, the angle α is chosen to be equal to or greater than 9°. In general, the relation between the dm·n value and the angle α is expressed by the following equation:

α≧{0.056×dₘ×n×10⁻⁴}−2

wherein dₘ represents the pitch circle diameter (mm) of the circular row of the rolling elements 4 and n represents the rotational velocity (min⁻¹) of the inner ring 2.

A portion of the inclined surface portion 2b is formed with a circumferentially extending groove 7 of a generally V-shaped configuration. The generally V-shaped circumferential groove so formed is delimited by an axially inner side face 7a which forms a inclined side face and an axially outer side face 7b which forms a radial face. The transit area between the inclined side face 7a and the inclined surface portion 2b represents a smoothly curved line. The V-shaped circumferential groove 7 is defined at an axial position on the inclined surface portion 7a that is axially rearwardly of the point intermediate of the width of the inclined surface portion 2b.

The grease tank 10 referred to previously is an annular component having a hollow grease reservoir 11 defined within such component and is made up of a grease tank body 12 and a grease tank tip member 13. More specifically, the grease tank body 12 is delimited by an axially lying inner peripheral wall portion 12a, an outer peripheral wall portion 12b parallel to the inner peripheral wall portion 12a and a rear wall portion 12c bridging between respective rear ends of the inner and outer peripheral walls 12a and 12b. Also, the grease tank tip member 13 is held in position having been inserted in between the inner peripheral wall portion 12a and the outer peripheral wall portion 12b so as to close the opening of the grease tank body 12 that confronts the rear side of the bearing assembly 1.

The grease tank tip member 13 has its inner peripheral portion representing a tubular portion 13a protruding towards the rolling bearing assembly 1, and a medium insertion gap 14 is defined between an inner diametric surface of an base end of the tubular portion 13a and a portion of an outer diametric surface of the inner peripheral wall portion 12a adjacent the rolling bearing assembly 1. This medium insertion gap 14 is so sized as to accommodate therein the base oil transfer medium 15, as will be detailed later, that is inserted thereinto.

The tubular portion 13a of the grease tank tip member 13 protrudes beyond the medium insertion gap 14 in a direction axially towards the rolling bearing assembly 1 so as to overhang the inclined surface portion 2b of the inner ring 1 with a clearance 61 left between it and the inclined surface portion 2b. The tubular portion 13a has a tip area formed with a projection portion 13b protruding in a direction towards the inner periphery thereof. This projection portion 13b has a side face oriented towards the medium insertion gap 14 is tapered radially inwardly and downwardly to define a tapered face 13c having its diameter gradually increasing towards the medium insertion gap 14. Accordingly, the inner diametric surface of a region of the tubular portion 13a, which protrude towards the axial intermediate point of the rolling bearing assembly 1 beyond the medium insertion gap 14 is so designed and so shaped to guide the tip of the base oil transfer medium 15, which is positioned outside the grease reservoir 11, to slidingly contact the steeply inclined side face 7a of the generally V-shaped circumferential groove 7 in the outer diametric surface of the outer ring 2.

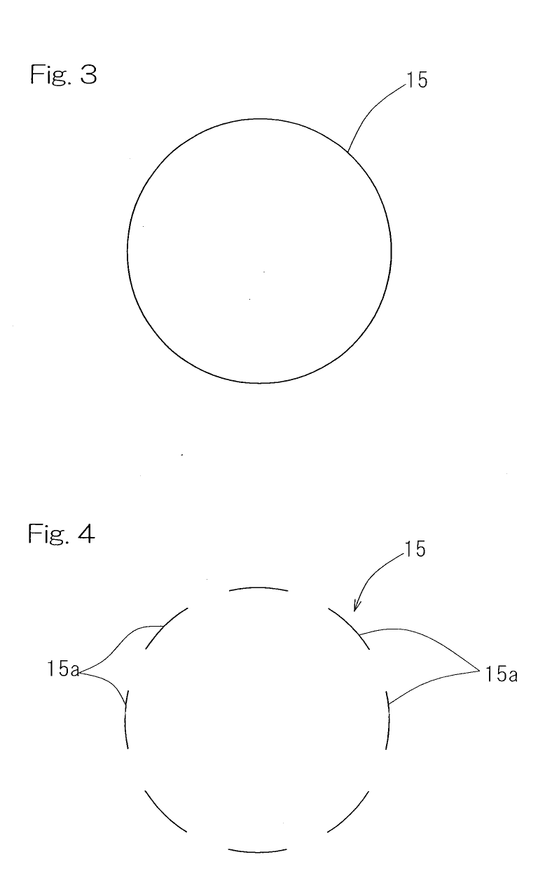

The grease reservoir 11 of the grease tank 10 accommodates therein a quantity of grease filled therein. Also, this grease reservoir has the base oil transfer medium 15 inserted therein, which medium 15 is a member separate from the grease tank 10 and has one end extending completely through the medium insertion gap 14 to the outside of the grease reservoir 11. The base oil transfer medium 15 is operable to extract a base oil from the grease and then allow the extracted base oil to be transferred therethrough by the effect of the well known capillary phenomenon and, for this purpose, the base oil transfer medium 15 is prepared from, for example, a piece of Japanese Washi paper fabric, leather, felt or the like. The Japanese Washi paper refers to a kind of paper prepared from a vegetable material such as, for example, linen, a kouzo plant, or mitsumata plant. The fabric used as the base oil transfer medium 15 may be either woven or non-woven fabric. The opposite end of the base oil transfer medium 15 remaining within the grease reservoir 11 preferably extends to a position in the vicinity of the rear wall portion 12c of the grease tank body 12. This base oil transfer medium 15 may be provided over the entire circumference after having been shaped to a substantially cylindrical shape as shown in FIG. 3. Alternatively, the base oil transfer medium 15 may be made up of a plurality of base oil transfer branched portions 15a, each having an arbitrarily chosen width as measured in a circumferential direction, which branched portions 15a are arranged having been dispersed over the entire circumference as shown in FIG. 4. In the case of the use of the base transfer branched portions 15a, the circumferential length of the base oil transfer medium 15 itself can be adjusted so that the amount of the base oil extracted can be adjustable.

The grease tank 10 is made of either a steel material or a resinous material. In either case, it can be easily formed by means of a mechanical processing. Particularly where the grease tank 10 is made by the use of the resinous material, it can be formed by the use of any known injection molding technique. The injection molding technique makes it possible to provide a more inexpensive grease tank 10 than that afforded by the use of the mechanical processing.

The grease tank 10 referred to above is so assembled as to assume a position next to the rolling bearing assembly 1 with one end face of the grease tank tip member 13 adjacent the rolling bearing assembly 1 held in contact with a rear end face of the outer ring 3 adjacent the rear open end of the annular bearing space. That portion of the base oil transfer medium 15 protruding outwardly of the grease reservoir 11 is brought into contact with the tapered face 13c of the tubular portion 13a and then extend radially inwardly with its tip lightly contacting the steeply inclined side face 7a of the V-shaped circumferential groove 7. The inclined surface portion 2b of the inner ring 2 and the projection portion 13b of the grease tank tip member 13 are spaced from each other a distance representing the clearance 61 as hereinbefore described. An O-ring 16 is interposed between an annular front end face of the outer peripheral wall portion 12b of the grease reservoir body 12 and the rear end face of the outer ring 3.

In a condition with the grease tank 10 having been assembled in the manner described above, an outer ring spacer 17 made of a steel material and having a stepped face 17a defined in an inner periphery thereof is mounted on the outer periphery of the grease tank 10 with a rear end of the outer peripheral wall portion 12b of the grease reservoir body 12 remote from the rolling bearing assembly 1 engaged with the stepped face 17a. Accordingly, the grease tank 10 is constrained in axial direction. It is to be noted that the inner ring 2 is positioned by an inner ring spacer 18. The outer ring spacer and the inner ring spacer are made of a steel material.

Referring to FIG. 5, there is shown one example of a main shaft device employing the lubrication structure for the rolling bearing assembly shown in and described with particular reference to FIGS. 1 and 2. This main shaft device is of a type used in a machine tool and includes a main shaft 20 having a free end 20a, to which a chuck (not shown) for holding a tool or a work is fitted, and a base end 20b opposite to such free end and drivingly connected with a drive source such as, for example, a motor through a rotation transmitting mechanism (not shown). The main shaft 20 is rotatably supported by a pair of rolling bearings that are spaced a distance from each other in a direction axially of such main shaft 20. In the instance as shown, the pair of the rolling bearings, each represented by the rolling bearing assembly 1 referred to previously, are disposed in back-to-back relation to each other. The inner ring 2 of each of those rolling bearing assemblies 1 is mounted on an outer diametric surface of the main shaft 20 whereas the outer ring 3 thereof is mounted on an inner diametric surface of a bearing box 21. The inner and outer rings 2 and 3 are positioned by the inner ring spacer 18 and the outer ring spacer 17, respectively, and fixed to the main shaft 20 and the bearing box 21, respectively, by means of an inner ring retaining spacer 22 and an outer ring retaining plug 23. Also, the grease tank 10 is disposed rearwardly of each of those rolling bearing assemblies 1.

The operation of the lubrication structure of the design described hereinabove will now be described.

During the assemblage, the grease is filled into the inside of the rolling bearing assembly 1 and, also, the grease is filled in the grease reservoir 11 of the grease tank 10. Lubrication of the bearing assembly is carried out by the grease that is initially filled and also by the utilization of the extraction and transfer of the grease base oil within the grease tank 10 that occur by the effect of the capillarity exhibited by the base oil transfer medium 15. More specifically, as the grease base oil extracted by the base oil transfer medium 15 flows out of the grease reservoir 11 and then adheres to the steeply inclined side face 7a of the circumferential groove 7 in the inner ring 2. The base oil so adhering to the inclined side face 7a in the manner described above moves towards and then adheres to the inclined surface portion 2b of the inner ring 2 and further moves in a direction towards the inside of the bearing assembly while adhering to the inclined surface portion 2b by the effect of a surface tension of the base oil and a centrifugal force developed as the inner ring 2 is rotated. Since the transit between the steeply inclined side face 7a and the inclined surface portion 2b, that are continued with each other, depicts a smoothly curved line, the movement of the base oil from the steeply inclined side face 7a to the inclined surface portion 2b takes place smoothly. Also, because the clearance 61 delimited between the inclined surface portion 2b of the inner ring 2 and the projection portion 13b of the grease tank tip member 13 is small and the pumping function is exhibited as the inner ring 2 is rotated, not only can the movement of the base oil along the inclined surface portion 2b be facilitated, but also a sealing effect, by which the leakage of the grease from the bearing assembly is avoided, can be expected. The base oil reaching a boundary edge of the inclined surface portion 2b adjacent the rolling surface 2a is radially outwardly scattered by the effect of the centrifugal force to thereby adhere to surfaces of the rolling elements 4 and inner faces of the pockets 5a of the ball retainer 5 and is therefore utilized as a lubricant oil.

At the halt of the operation, an oil adhering to the inclined surface portion 2b of the inner ring 2 and an oil supplied from the grease within the grease reservoir 11 by and through the base oil transfer medium 15 are temporarily retained within the circumferential groove 7. At the time of starting, upon the rotation of the inner ring 2, the oils retained within the circumferential groove 7 are utilized again as a lubricant oil. For this reason, the lubrication can take place at all times with the abundant lubrication oil. In this way, because in addition to the initially filled grease inside the bearing assembly, the grease reservoir 11 contains the grease, not only is the reliability of lubrication be high, but also the increase of the lifetime of the bearing assembly can be realized.

Where the pair of the rolling bearing assemblies 1 are employed having been arranged in back-to-back relation to each other such as observed in, for example, the main shaft device shown in and described with reference to FIG. 5, the grease tank 10 may be disposed rearwardly of the rolling bearing assemblies 1. According to this construction, there is no need to employ any component part for lubrication purpose on the front side of each of the rolling bearing assemblies 1. For this reason, the design can be achieved, in which the distance from the rolling bearing assemblies 1 to the free end 20a of the main shaft 20, to which the tool or the work is fitted, is minimal. The smaller the distance between the rolling bearing 1 and the free end 20a of the main shaft 20, the larger the moment rigidity relative to an external force load acting on the tool. It is, however, to be noted that, if moment rigidity is not required, the grease tank 10 may be disposed on the front side of the rolling bearing assembly 1.

Since the base oil of the grease filled within the grease reservoir 11 of the grease tank 10 is utilized as the lubricant oil, neither an oil tank nor piping is needed to be disposed outside the bearing assembly. Also, the bearing box 21 need not be highly precisely processed to have an oil introducing hole or the like. For this reason, the structure can be simplified and can be manufactured at a low cost. Yet, since there is no need to use a large amount of oil nor any driving power for the lubrication, it is preferred in terms of the energy saving and resource saving. In addition, because of the lubrication with the grease, no maintenance servicing is required.

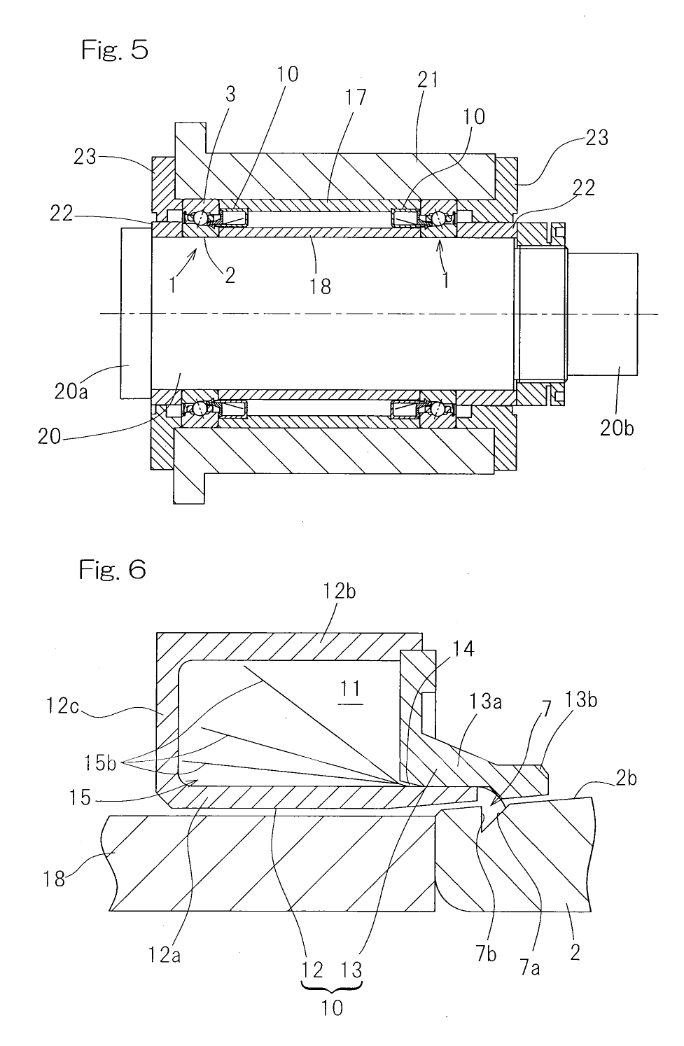

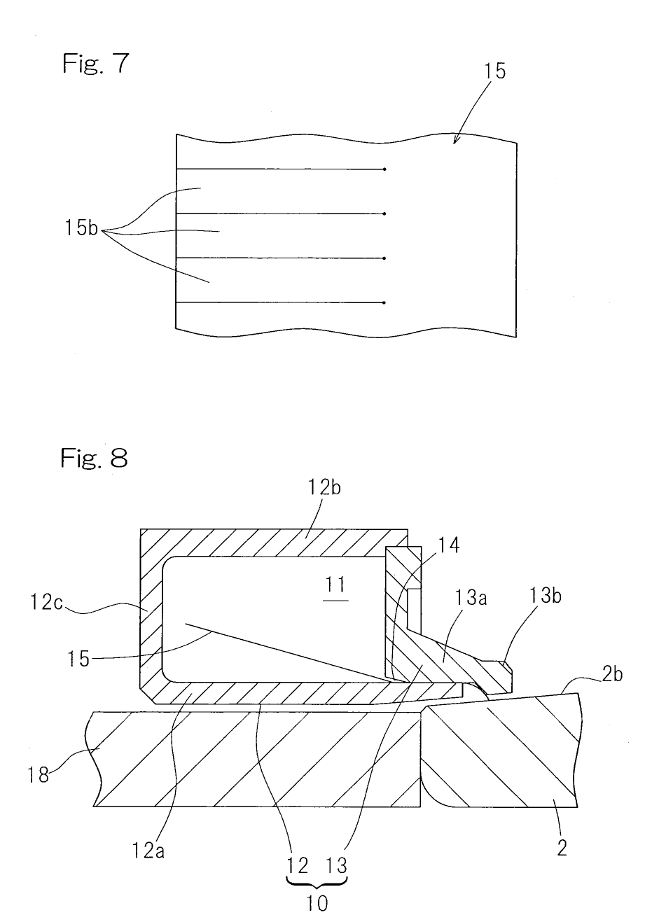

FIGS. 6 and 7 illustrate a second embodiment of the present invention, in which a different base oil transfer medium 15 is employed. As best shown in FIG. 7, that portion of the base oil transfer medium 15 which is inserted into the grease reservoir 11 is branched into a plurality of branched portions 15b that are separable from each other in a direction circumferentially thereof. If that portion of the base oil transfer medium 15 which is inserted into the grease reservoir 11 is so ramified into the medium strips 15b as hereinabove described, those medium strips 15b can be disposed having been dispersed over a large region of the grease reservoir 11 and, therefore, the base oil can be efficiently extracted from the entire region of the grease reservoir 11.

FIG. 8 illustrates a third embodiment of the present invention, in which no circumferential groove 7 is employed in the inclined surface portion 2b of the inner ring 2. That portion of the base oil transfer medium 15, which protrudes outwardly from the grease reservoir 11, has a tip held in contact with the inclined surface portion 2b. In this embodiment shown in FIG. 8, the base oil extracted from the grease within the grease reservoir 11 by and through the base oil transfer medium 15 adheres to the inclined surface portion 2b of the inner ring 2. The other function than that described hereinabove is substantially similar to that exhibited in the previously described embodiment or embodiments. Although the previously described circumferential groove 7 may be used because the function of the oil being retained within the circumferential groove 7 at the halt of the operation can be obtained as hereinbefore described, the increase of the reliability of lubrication and also the increase of lifetime of the bearing assembly can be accomplished even without the circumferential groove 7. The absence of the circumferential groove 7 such as realized in the practice of the embodiment shown in and described with reference to FIG. 8 makes it possible to facilitate the processing of the inner ring 2 and, accordingly, such an advantage can be appreciated that the inner ring 2 can be manufactured at a low cost.

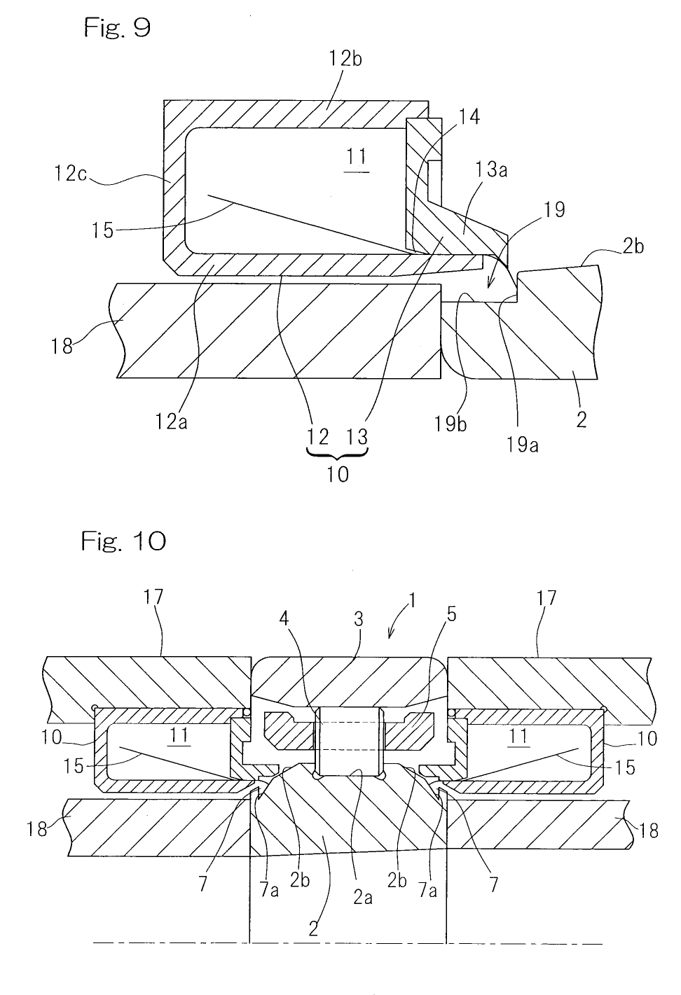

FIG. 9 illustrates a fourth embodiment of the present invention, in which in place of the previously described circumferential groove 7 in the inner ring 2, a stepped area 19 is formed in the inner ring 2. This stepped area 19 is made up of a radial upright face 19a, continued from the inclined surface portion 2b and lying perpendicular to the longitudinal axis O of the bearing assembly, and a substantially cylindrical face 19b extending axially outwardly from a radially inward end of the radial upright face 19a. The radial upright face 19a and the inclined surface portion 2b are continued with each other through a smoothly curved line. In a broad sense, the radial upright face 19a forms a part of the inclined surface portion 2b. The tip of that portion of the base oil transfer medium 15, which protruded outwardly from the grease reservoir 11, is held in contact with the radial upright face 19a. In this embodiment, the base oil extracted from the grease within the grease reservoir 11 by and through the base oil transfer medium 15 adheres first to the radial upright face 19a and is then transmitted from the radial upright face 19a to the inclined surface portion 2b to flow into the bearing assembly. Even with the use of the stepped area 19 in the inner ring 2, it is possible to facilitate the processing of the inner ring 2 and, accordingly, such an advantage can be appreciated that the inner ring 2 can be manufactured at a low cost.

The lubrication structure of the present invention can be applied to the rolling bearing assembly 1 which is a cylindrical roller bearing assembly as shown in FIG. 10 showing a fifth embodiment. In this embodiment, opposite sides of the rolling surface 2a in the rolling bearing assembly 1 are formed as respective inclined surface portions 2b, and each of the inclined surface portions is formed with the circumferential groove 7. The grease tank 10 is disposed on each side of the rolling bearing assembly 1, and the tip of the base oil transfer medium 15 provided in the respective grease tank 10 is held in contact with the steeply inclined side face 7a of the circumferential groove 7 adjacent the rolling surface 2a. Even with the structure shown in and described with reference to FIG. 10, functions and effects similar to those afforded by the angular contact ball bearing employed for the rolling bearing assembly 1 can be obtained. Although in the instance as shown in FIG. 10, the grease tank 10 has been shown and described as employed on each side of the rolling bearing assembly 1, it may be employed only on one side of the rolling bearing assembly 1 provided that the lubricating condition be satisfied.

Although in describing any of the foregoing embodiments of the present invention, reference has been made to the lubrication structure used in the rolling bearing assembly or assemblies for rotatably supporting the machine tool main shaft, the lubrication structure of the present invention can be equally applied not only to the bearing assembly for use with the machine tool main shaft, but also to the rolling bearing assembly for use with, for example, a motor or any other work machine.

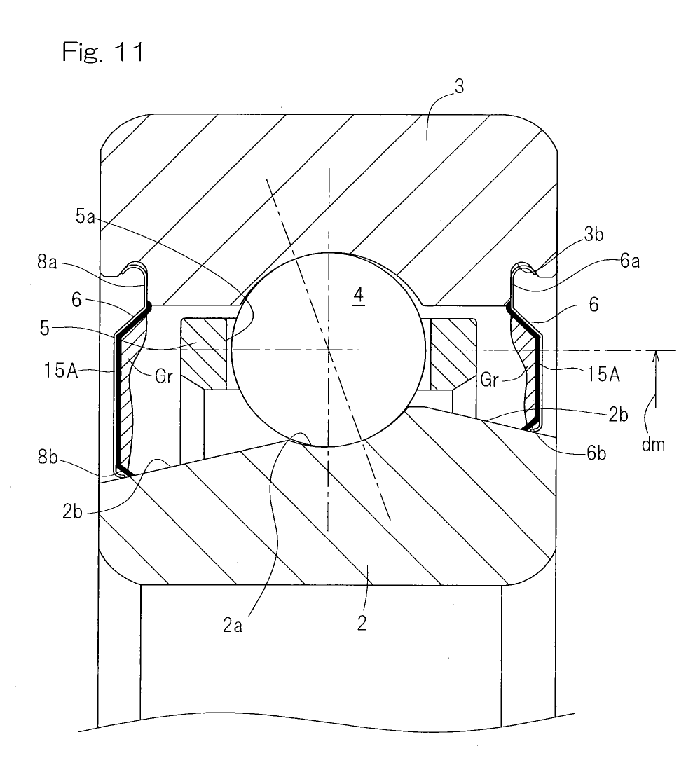

In the description that follows, sixth to eleventh embodiments of the present invention, all of which pertain to the rolling bearing assembly of the present invention, will be described in detail with particular reference to FIGS. 11 to 17. It is, however, to be noted that in the description that follows, component parts similar to those shown and described in connection with the preceding embodiments of the present invention are shown by like reference numerals and, therefore, the details thereof are not reiterated for the sake of brevity. Where only a part of the construction is described, the remaining part of the construction is to be understood as similar to that in the preceding embodiment or embodiments. It is also to be noted that it is possible not only to combine components specifically described in connection with each of the foregoing and following embodiments of the present invention, but also to partially combine two or more of the foregoing and following embodiments.

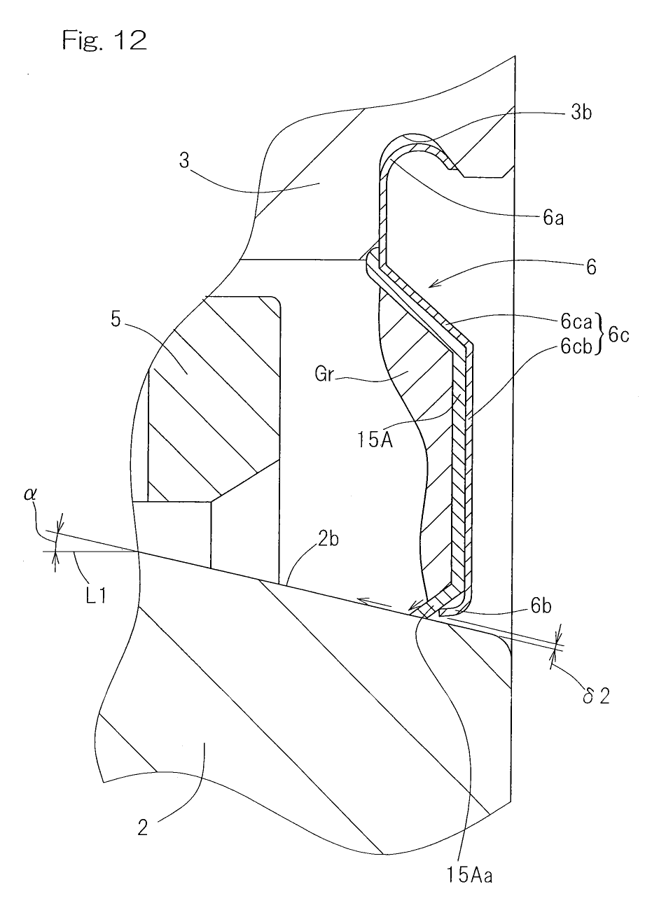

The sixth embodiment of the present invention pertaining to the rolling bearing assembly of the present invention will first be described with particular reference to FIGS. 11 and 12.

The rolling bearing assembly designed in accordance with the sixth embodiment includes, as best shown in FIG. 11, an inner ring 2, an outer ring 3, a plurality of rolling elements 4 and a ball retainer 5, all similar to those employed in the previously described first embodiment, but is not provided with the grease tank 10 of the type having the grease reservoir 11 formed therein as is the case with that in the previously described first embodiment. It differs from that according to the first embodiment in that the opposite annular open ends of the bearing space delimited between the inner and outer rings 2 and 3 are sealed by sealing members 6 and 6 with the grease filled within the inside of the bearing assembly and that respective inner wall faces of those sealing members 6 and 6 are provided with respective base oil transfer mediums 15A as will be described in detail later. It is to be noted that the rolling bearing assembly in this instance is in the form of an angular contact ball bearing and is rendered to be of an inner ring rotating type. However, the rolling bearing assembly is not necessarily limited to the angular contact ball bearing. For the rolling bearing assembly, a deep groove ball bearing, a cylindrical roller bearing or a tapered roller bearing may be used for the rolling bearing assembly.

The sealing members 6 will be described in detail.

As shown in FIGS. 11 and 12, shields of a steel material as the sealing members 6 are fitted to the opposite ends of the outer rings 3, thus rendering the bearing assembly to be a sealed rolling bearing. The inner diametric surface of the outer ring 3 has its opposite end portions formed with respective sealing member fixing grooves 3b defined therein so as to be depressed radially outwardly beyond the outer ring inner diameter. On the other hand, the outer diametric surfaces 2b on opposite end portions of the inner ring 2 are provided with respective inclined surface portions (as will be detailed later), having diameters gradually increasing from the end face side towards the rolling surface 2a side, with which corresponding inner peripheral edge portions 15Aa of the associated base oil transfer mediums 15A contact.

As best shown in FIG. 12, each of the sealing members 6 has a radially outward base portion 6a that is fixed in the corresponding sealing member fixing groove 3b. Each of the sealing members 6 also has a radially inward tip portion 6b that is so shaped as to represent a generally L-shaped configuration having been bent or otherwise curved towards its tip, terminating at a location spaced a predetermined small distance radially inwardly from the associated inclined surface portion 2b of the outer diametric surface so as to leave a respective clearance 62. This clearance 62 is of a size enough to provide a sealing effect. As described above, in the sixth embodiment of the present invention, each of the sealing members 6 is held in non-contact relation with the corresponding inclined surface portion 2b of the outer diametric surface of the inner ring 2.

An intermediate portion 6c of each of the sealing member 6 that continues to the base portion 6a includes an inclined portion 6ca and an radially upright portion 6cb. In other words, in each of the sealing members 6, the inclined portion 6ca that inclines in a direction towards the outside of the bearing assembly as it goes in a radially inward direction is continued to an inner peripheral edge of the base portion 6a and the radially upright portion 6cb is continued to an inner peripheral edge of the inclined portion 6ca. The radially upright portion 6ca is provided along a plane perpendicular to the longitudinal axis of the bearing assembly and the inner peripheral edge of this radially upright portion 6cb is continued to the radially inward tip portion 6b.

The base oil transfer medium 15A of an annular configuration and made of a material effective to give rise to the capillary phenomenon is provided in each of the inner wall face of each of the sealing members 6. Specifically, the respective base oil transfer medium 15A is fixed to an inner peripheral portion of the radially outward base portion 6a, inclined portion 6ca and radially upright portion 6cb of the inner wall face of each sealing member 6. The entire circumference of the inner peripheral edge portion 15Aa of the base oil transfer medium 15A is held in contact with the corresponding inclined surface portion 2b of the outer diametric surface of the inner ring 2. More specifically, the inner peripheral edge portion 15Aa of each base oil transfer medium 15Aa is inclined inwardly of the bearing assembly as it goes towards the tip thereof and is retained by the radially inward tip portion 6b of the generally L-shaped configuration. The same material as that used for the base oil transfer medium employed in the practice of any one of the previously described embodiments may be applied also for each of the base oil transfer mediums 15A.

Also, a portion of the grease filled in the annular bearing space delimited between the inner and outer rings 2 and 3 is caused to adhere to the inner wall face of each of the sealing members 6. The grease caused to adhere to this inner wall face is referred to as “sealing member wetting grease Gr”. In the instance now under discussion, the sealing member wetting grease Gr is caused to adhere to the inner wall face of each of the sealing members 6 by the effect of the operation of the bearing assembly, but as will be described subsequently, the sealing member wetting grease Gr may be caused to adhere to the inner wall face of each of the sealing members 6 during the assemblage of the bearing assembly.

The previously described inclined surface is provided in the inclined surface portion 2b of the outer diametric surface of the inner ring 2. Although in the instance now under discussion, the entire inclined surface portion 2b of the outer diametric surface is rendered to be an inclined surface, only a part of the outer diametric surface of the inner ring 2 may be rendered to be an inclined surface.

Since the centrifugal force which may act on the grease differs depending on the rotational velocity, the inclination angle of the outer diametric surface of the inner ring 2 relative to an axial direction L1 may be chosen in dependence on the allowable number of revolutions or the service number of revolutions of the bearing assembly. At this time, when the inclination angle of the outer diametric surface of the inner ring 2 is chosen to be α, the pitch circle diameter of the circular row of the rolling elements is chosen to be dₘ (mm) (FIG. 11) and the rotational velocity is chosen to be n (min⁻¹), and if the inclination angle α is given using the following equation, the base oil adhering to the inclined surface of the inner ring 2 flows towards the rolling surface 2a and then contributes to the lubrication and, therefore, it is further preferred.

α≧{0.056×dₘ×n×10⁻⁴}−2

Here, the value of the pitch circle diameter dₘ (mm) of the circular row of the rolling elements multiplied by the rotational velocity n (min⁻¹) is referred to as the dm·n value.

The grease present on the rolling surface as a result of the operation of the bearing assembly is trodden upon by rolling elements 3 and does therefore get in part paddled sideways outwardly and in part scattered to adhere to the respective the inner wall faces of sealing members 6 provided at both ends of the bearing assembly. According to the bearing assembly of the structure described hereinabove, since the base oil transfer medium 15A is provided in the inner wall face of each of the sealing members 6 and the inner peripheral edge portion 15Aa of each of the base oil transfer mediums 15A is held in contact with the corresponding inclined surface portion 2b of the outer diametric surface of the inner ring 2, only the base oil of the sealing member wetting grease Gr adhering to the inner wall face of the respective sealing member 6, which is required for the lubrication, is caused to adhere to the corresponding inclined surface portion 2b of the outer diametric surface of the inner ring 2 through the associated base oil transfer medium 15A by the effect of capillarity. As the inner ring 2 rotates, the base oil adhering to the corresponding inclined surface portion 2b of the outer diametric surface of the inner ring 2 flows towards the rolling surface 2a of the inner ring 2 by the effect of the centrifugal force and the surface tension while adhering to such inclined surface portion 2b.

By those two functions, that is, the function of the capillary phenomenon and the function of attachment flow the sealing member wetting grease Gr contributes to the lubrication of the bearing assembly.

Where a portion of the grease filled within the annular bearing space is caused to adhere to the inner wall face of each of the sealing members 6 during the assemblage of the bearing assembly, as a result of the operation of the bearing assembly, the base oil of the grease adhering to the inner diametric surface of the outer ring 3, which has been scattered from, for example, a side of the rolling surface, hooks upon the base oil of the grease adhering to the inner wall face of each of the sealing members 6. Accordingly, it is possible to smoothly supply the base oil within the sealer wetting grease to each of the inclined surface portions 2b of the outer diametric surface of the inner ring 2. In this way, the base oil of a portion of the grease which has hitherto hardly contributed to the lubrication, contributed to a smooth lubrication of the bearing assembly after having adhered to the inclined surface portions 2b of the outer diametric surface of the inner ring 2 through the base oil transfer mediums 15A. Accordingly, it is possible to increase the lifetime of the bearing assembly with the same amount of the filled grease as that that has hitherto been practiced. Also, since the amount of the grease filled in the vicinity of the rolling surface can be reduced, it is possible to reduce the initial break-in time.

Since the entire circumference of the inner peripheral edge portion 15Aa of each of the base oil transfer mediums 15A is held in contact with the corresponding inclined surface portion 2b of the outer diametric surface of the inner ring 2, the amount of the base oil transferred, per unitary time, from the sealing member wetting grease Gr towards the corresponding inclined surface portion 2b of the outer diametric surface of the inner ring 2 can be increased. Accordingly, the rolling bearing assembly can be used under a high speed and a medium and high load.

Each of the base oil transfer mediums 15A is fixed to an inner peripheral portion of the radially outward base portion 6a, inclined portion 6ca and radially upright portion 6cb of the inner wall face of each of the sealing members 6. Also, since the inner peripheral edge portion 15Aa of each base oil transfer medium 15A is inclined inwardly of the bearing assembly as it goes towards the tip thereof and is retained by the radially inward tip portion 6b of the generally L-shaped configuration, it is possible to cause the sealing member wetting grease Gr to stably deposit within an annular recessed groove bound by the inclined portion 6ca, the radial upright portion 6cb and the tip portion 6b. The same material as that used for the base oil transfer medium employed in the practice of any one of the previously described embodiments of the present invention can be applied also for each of the base oil transfer mediums 15Aa. Without any complicated structure employed, it is possible to gradually supply only the base oil from the sealing member wetting grease Gr then adhering stably to the annular recessed groove referred to above.

Since each of the sealing members 6 is rendered to be non-contact with the corresponding inclined surface portion 2b of the outer diametric surface of the inner ring 2, this rolling bearing assembly can be suitably used as, for example, a machine tool bearing for use in a machine tool, which requires a low torque is desired in terms of the low heat dissipation and the energy saving, or a bearing for use with a machine used in a general industrial machine.

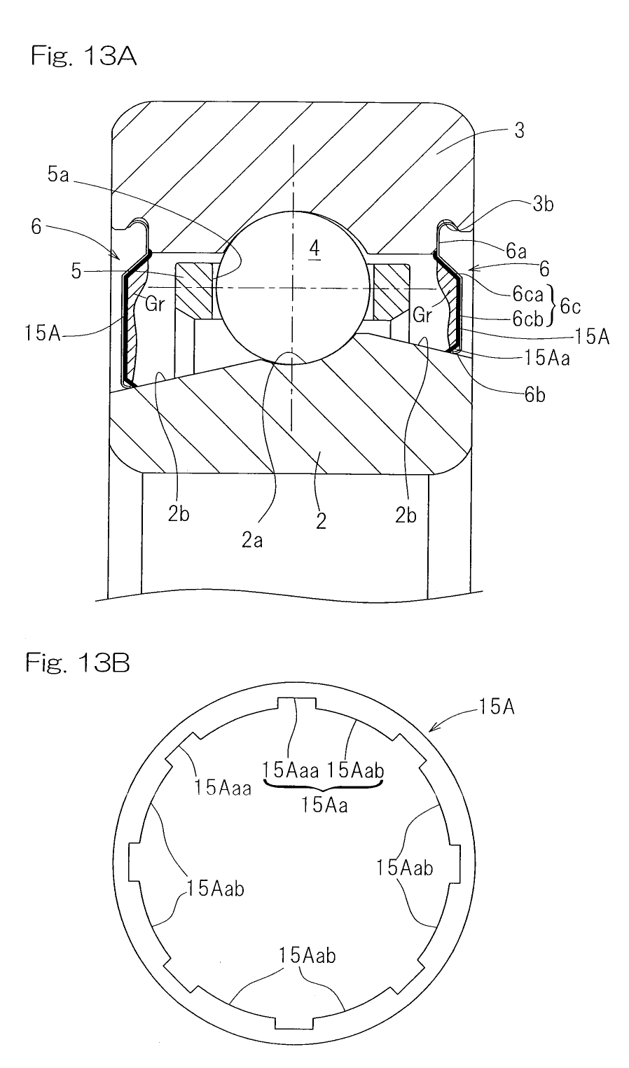

As shown in FIGS. 13A and 13B, a portion of the inner peripheral edge portion 15Aa of each of the base oil transfer mediums 15A may be held in contact with the corresponding inclined surface portion 2b of the outer diametric surface of the inner ring 2. FIG. 13B is a schematic end view showing only the inner peripheral edge portion 15Aa of each of the base oil transfer mediums 15A in the rolling bearing assembly, shown in and described with reference to FIG. 13A, as viewed in a direction conforming to the longitudinal axis O of the bearing assembly.

The inner peripheral edge portion 15Aa of each of the base oil transfer mediums 15A is formed with a plurality of radially outwardly depressed recessed portions 15Aaa spaced a constant distance from each other in a direction circumferentially thereof. The inner peripheral edge portion 15Aa is provided with the plurality of the radially outwardly depresses recessed portions 15Aaa and a corresponding radially inward protrusions 15Aab that are positioned next to each other and alternate with each other in the circumferential direction, and a plurality of, for example, eight, radially inward protrusion portions 15Ab out from those radially inward protrusion portions 15Ab are held in contact with the corresponding inclined surface portion 2b of the outer diametric surface of the inner ring 2. As described above, by limiting points of contact of each of the base oil transfer mediums 15A with the inner ring outer diametric surface in the manner described above, the amount of the base oil transferred, per unitary time, from the sealing member wetting grease Gr towards the corresponding inclined surface portion 2b of the outer diametric surface of the inner ring 2 decreases. Accordingly, the rolling bearing assembly can be used for a long period.

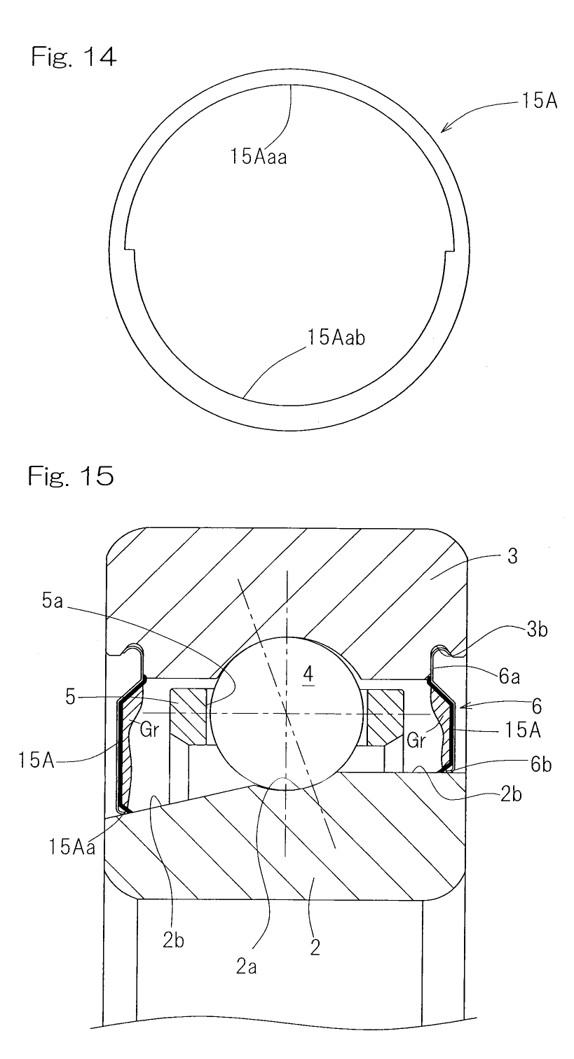

FIG. 14 illustrates a schematic end view showing only the inner peripheral edge portion 15Aa of each of the base oil transfer mediums 15A in the rolling bearing assembly according to an eighth embodiment, as viewed in a direction conforming to the longitudinal axis of the bearing assembly. As shown therein, in the inner peripheral edge portion 15Aa of each of the base oil transfer mediums 15A, respective intermediate portions spaced 180° from each other in the direction circumferentially of the associated base oil transfer medium 15A may be formed as a radially inwardly recessed portion 15Aaa and a radially outwardly protrusion portion 15Aab. Even in this case, as is the case with that afforded by the previously described embodiment shown in and described with reference to FIGS. 13A and 13B, since the amount of the base oil transferred, per unitary time, from the sealing member wetting grease Gr towards the corresponding inclined surface portion 2b of the outer diametric surface of the inner ring 2 decreases, the rolling bearing assembly can be used for a further long period.

In place of the structural feature in which the opposite sides of the outer diametric surface of the inner ring 2 are rendered to be the inclined surface portion 2b, only one of the opposite sides of the outer diametric surface of the inner ring 2 may be rendered to be a flat surface area parallel to the longitudinal axis of the bearing assembly as shown in FIG. 15. In this case, only the base oil contained in the sealing member wetting grease Gr and required for the lubrication, can be caused to adhere to the outer diametric surface of the inner ring 2 through the base oil transfer mediums 15A by the utilization of the capillary phenomenon, thus contributing to the lubrication.

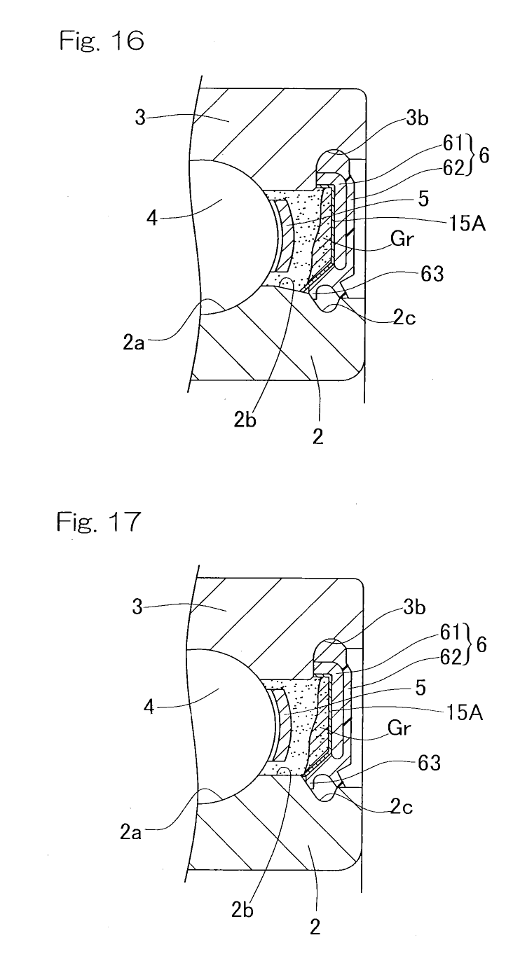

As is the case with a tenth embodiment shown in FIG. 16, as each of the sealing members 6, a seal formed by reinforcing a corresponding elastic body 61 with a respective core metal 62. In the example shown in FIG. 16, each of the inclined surface portions 2b of the outer diametric surface of the inner ring 2 is formed with an annular seal groove 2c, with which a sealing lip 63 contacts, and, hence, a contact seal is employed as the sealing member. Also, the rolling bearing is applied in the form of a deep groove ball bearing and an iron plate corrugated retainer is applied as the retainer 5.

As is the case with an eleventh embodiment shown in FIG. 17, a seal is applied as each of the sealing members 6 and each of the inclined surface portions 2b of the outer diametric surface of the inner ring 2 may be formed as a flat surface area parallel to the longitudinal axis of the bearing assembly in a manner similar to that shown in and described with particular reference to FIG. 15.

By way of example, in a bearing assemblies for use in railroad vehicles, an automotive vehicles and wind mills, which generally attach importance to the water proofing and the dust proofing, it is preferred that each of the sealing members 6 be constructed as a non-contact type as shown respectively in FIGS. 16 and 17 and described respectively in connection with the tenth and eleventh embodiments.

Depending on the condition of use, the sealing member 6 and the base oil transfer medium 15A may be provided only on one side of the bearing assembly. In this case, the inclined surface portion may be provided only in the outer diametric surface of the inner ring on that side where the base oil transfer medium 16A is provided. Although the embodiments of FIGS. 16 and 17 make use of the contact seal, a non-contact seal may be used. In the rolling bearing assembly referred to in connection of any one of the foregoing embodiments of the present invention, the ball retainer may not be essential and may therefore be dispensed with.

The sixth to eleventh embodiments, in which no grease tank is used, may include the following mode in which no inclined surface portion is employed.

### [Mode 1]

The rolling bearing assembly according to the mode 1 includes inner and outer rings, a plurality of rolling elements interposed between those inner and outer rings and a sealing device provided in the outer ring for sealing a bearing space delimited between the inner and outer rings, in which the use is made of an annular base oil transfer medium made of a material effective to give rise to the capillary phenomenon and capable of transferring a base oil of a grease, which medium has an inner peripheral edge portion held in contact with an outer diametric surface of the inner ring.

Although the present invention has been fully described in connection with the embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Rolling bearing assembly
2 . . . Inner ring
2a . . . Rolling surface
2b . . . Inclined surface portion
3 . . . Outer ring
6 . . . Sealing device (Sealing member)
7 . . . Circumferential groove
7a . . . Inclined side face (Side face)
8 . . . Sealing device
10 . . . Grease tank
11 . . . Grease reservoir
13a . . . Tubular portion
14 . . . Medium insertion gap
15, 15A . . . Base oil transfer medium
15b . . . Medium strip
19 . . . Stepped area
19a . . . Annular radial upright face
20 . . . Main shaft
O . . . Longitudinal axis of the bearing assembly

What is claimed is:

1. A lubrication structure for a rolling bearing assembly that has inner and outer rings; a plurality of rolling elements interposed between those inner and outer rings, comprising:
an inclined surface portion defined in an outer diametric surface of the inner ring that serves as a rotating member and extending laterally from a rolling surface of the inner ring;
a grease tank having a grease reservoir defined therein, the grease tank being disposed adjacent the outer ring of the rolling bearing assembly; and
a base oil transfer medium disposed within the grease reservoir of the grease tank for transferring a base oil of the grease by means of a capillary phenomenon,
wherein the base oil transfer medium has one end held in contact with the inclined surface portion to allow the base oil of the grease, filled within the grease reservoir, to be transferred through the base oil transfer medium to adhere to the inclined surface portion, whereby the base oil adhering to the inclined surface portion is supplied into the rolling bearing assembly by the utilization of a surface tension of the base oil and an attachment flow of the base oil along the inclined surface portion that is induced upon rotation of the inner ring.

2. The lubrication structure for the rolling bearing assembly as claimed in claim 1, wherein the grease tank has a medium insertion gap defined therein for communicating the grease reservoir to the outside, the base oil transfer medium being inserted in this medium insertion gap; an outer diametric side portion of the medium insertion gap in a shell of the grease tank is formed as a tubular portion that covers the inclined surface portion of the inner ring through a gap area; and an inner diametric surface of a portion of the tubular portion, which protrudes axially towards a center of the bearing assembly beyond the medium insertion gap, is so shaped as to guide a portion of the base oil transfer medium outside the grease reservoir to have a tip held in contact with the inclined surface portion.

3. The lubrication structure for the rolling bearing assembly as claimed in claim 1, wherein the inclined surface portion is provided with a generally V-sectioned circumferential groove, and one end of the base oil transfer member is held in contact with a inclined face of the circumferential groove that is adjacent the rolling surface.

4. The lubrication structure for the rolling bearing assembly as claimed in claim 1, wherein the inclined surface portion is provided with a stepped area having a small diameter thereof at a location remote from the rolling surface, one end of the base oil transfer medium being held in contact with a stepped face of the stepped area.

5. The lubrication structure for the rolling bearing assembly as claimed in claim 1, wherein the following equation establishes:
α≧{0.056×dₘ×n×10⁻⁴}−2
where the angle of the inclined surface portion relative to a bearing longitudinal axis is expressed by α (°), the pitch circle diameter of the rolling elements is expressed by dₘ (mm) and the rotational velocity is expressed by n (min⁻¹).

6. The lubrication structure for the rolling bearing assembly as claimed in claim 1, wherein a material for the base oil transfer medium is chosen to be at least one material having capillary phenomenon selected from the group consisting of Japanese Washi paper, a textile fabric including a non-woven fabric and a leather.

7. The lubrication structure for the rolling bearing assembly as claimed in claim 1, wherein the base oil transfer medium is provided in the grease tank such that the circumferential length of a portion of the base oil transfer medium, which contacts the inclined surface portion, is adjustable.

8. The lubrication structure for the rolling bearing assembly as claimed in claim 1, wherein a portion of the base oil transfer medium within the grease reservoir is branched into a plurality of branched portions that are separated from each other in a direction circumferentially thereof.

9. A rolling bearing assembly that has inner and outer rings; a plurality of rolling elements interposed between those inner and outer rings, comprising:
a sealing device provided in the outer ring for sealing a bearing space delimited between the inner and outer rings;
an inclined surface portion defined in an outer diametric surface of the inner ring; and having diameters gradually increasing from an end face side towards a rolling surface side
a base oil transfer medium of an annular shape made of a material capable of giving rise to a capillary phenomenon and provided in an inner wall face of the sealing device, at least a part of or the whole of the circumference of an inner peripheral edge portion of the base oil transfer medium being held in contact with an inclined surface portion of an outer diametric surface of the inner ring that serves as a rotatable member.

10. The rolling bearing assembly as claimed in claim 9, wherein the inclination angle of an inclined surface portion of an outer diametric surface of the inner ring is such an angle that, when the bearing assembly is rotated at a permissible rotational velocity or a service rotational velocity, the base oil flows towards the rolling surface side by the effect of a centrifugal force.

11. The rolling bearing assembly as claimed in claim 9, wherein both of the base oil transfer medium and an inclined surface portion of the outer diametric surface of the inner ring are provided only on one side or on opposite sides of the bearing assembly.

12. The lubrication structure for the rolling bearing assembly as claimed in claim 9, wherein the following equation establishes:
α≧{0.056×dₘ×n×10⁻⁴}−2
where the angle of the inclined surface portion relative to a bearing longitudinal axis is expressed by α (°), the pitch circle diameter of the rolling elements is expressed by dₘ (mm) and the rotational velocity is expressed by n (min⁻¹).

13. The rolling bearing assembly as claimed in claim 9, wherein a material for the base oil transfer medium is chosen to be at least one material having capillary phenomenon selected from the group consisting of Japanese Washi paper, a fabric and a leather.

14. The rolling bearing assembly as claimed in claim 9, wherein the sealing device is in non-contact with the outer diametric surface of the inner ring.

15. The rolling bearing assembly as claimed in claim 9, wherein the sealing device is in contact with the outer diametric surface of the inner ring.
